(19) United States
(12) Patent Application Publication
(10) Pub. No.: US 2025/0292659 A1
(43) Pub. Date: Sep. 18, 2025

(54) INFORMATION PROCESSOR AND GAME CONTROL METHOD

(71) Applicant: Universal Entertainment Corporation, Tokyo (JP)

(72) Inventors: Atsushi KUMITA, Tokyo (JP); Keiji SEKIGUCHI, Tokyo (JP); Satoko BABA, Tokyo (JP); Nobuyuki KAWARAI, Tokyo (JP); Hikaru IINUMA, Tokyo (JP); Takuya YAMAGUCHI, Tokyo (JP)

(21) Appl. No.: 19/069,401

(22) Filed: Mar. 4, 2025

(30) Foreign Application Priority Data
Mar. 14, 2024 (JP) 2024-040430

(51) Int. Cl. G07F 17/32

(52) U.S. Cl. CPC G07F 17/3267

(57) ABSTRACT

An object of the present invention is to provide an information processor which can reduce resources and a game control method. An information processor 1 is configured to switch a game state between (i) a first game state in which a first game which requires a bet is executed and (ii) a second game state in which a second game which does not require the bet is executed, depending on a predetermined condition. The game state includes the first game state and the second game state. The information processor 1 is configured to determine the number of execution times of the second game in the second game state. The information processor 1 is configured to: when the second game is executed the initial predetermined number of times in the second game state, set the display-use remaining number of game plays of the second game to a value obtained by subtracting one from an initial value each time the second game is executed, the initial value being set to be smaller than the number of execution times of the second game, the display-use remaining number of game plays of the second game being displayed on a display 120 as the remaining number of game plays of the second game; and set the actual remaining number of game plays of the second game as the display-use remaining number of game plays of the second game when the second game is executed after the second game has been executed the initial predetermined number of times.

### CROSS-REFERENCE TO RELATED APPLICATION

The present application claims priority from Japanese Patent Application No. 2024-040430, which was filed on Mar. 14, 2024, the disclosure of which is herein incorporated by reference in its entirety.

### FIELD OF THE INVENTION

The present invention relates to an information processor and a game control method.

### BACKGROUND OF THE INVENTION

A known stationary slot machine, a recent smartphone (an information processor) on which a slot game application is installed, and a recent social network game are each sometimes structured so that (i) random determination is performed in a normal game by betting a specified bet amount and (ii) symbols are rearranged based on a result of this random determination.

Typically, when some of the symbols rearranged by this random determination in the normal game form a predetermined combination, a benefit is awarded to a player. For example, a payout is awarded, or a normal state in which the normal game is executed is shifted to a special state which is more advantageous than the normal state. For example, a slot machine described in the specification of Japanese Laid-Open Patent Publication No. 2004-57221 is structured so that a free game which does not require a bet is executed in the special state. The number of game plays of the free game executed in the special state is determined by a free game play count determination game.

The known slot machine described above is typically configured to display the remaining number of game plays of the free game executable in the special state, and to update the remaining number of game plays of the free game each time the free game is executed. However, as the maximum number of game plays of the free game to be awarded is increased, resources such as an image for displaying the remaining number of game plays of the free game are also increased.

An object of the present invention is to provide an information processor which can reduce resources and a game control method.

### BRIEF SUMMARY OF THE INVENTION

An information processor of the present invention comprises:
a controller configured to switch a game state, depending on a predetermined condition, between (i) a first game state in which a first game which requires a bet is executed and (ii) a second game state in which a second game which does not require the bet is executed, the game state including the first game state and the second game state; and
a display configured to display how the first game and the second game progress, and
the controller is configured to:
determine the number of execution times of the second game in the second game state;
when the second game is executed an initial predetermined number of times in the second game state, set the display-use remaining number of game plays of the second game to a value obtained by subtracting one from an initial value each time the second game is executed, the initial value being set to be smaller than the number of execution times of the second game, the display-use remaining number of game plays of the second game being displayed on the display as the remaining number of game plays of the second game; and
set the actual remaining number of game plays of the second game as the display-use remaining number of game plays of the second game when the second game is executed after the second game has been executed the initial predetermined number of times in the second game state.

According to this, the remaining number of game plays of the second game in the second game state is not displayed as it is, and a value smaller than the actual remaining number of game plays of the second game is displayed and counted down as the initial predetermined number of times of the second game. With this arrangement, there is no need to display the maximum remaining number of awarded game plays of the second game. This makes it possible to reduce resources such as an image which is not displayed and to prevent the player from predicting whether the second game state in which the second game is executed continues.

The information processor of the present invention may be arranged so that
the controller is configured to set the initial value again when (i) the second game is executed the initial predetermined number of times and (ii) the display-use remaining number of game plays of the second game becomes zero.

According to this, resources used for a countdown can be repeatedly used. The maximum number of the resources used for a countdown is smaller than the actual remaining number of game plays of the second game.

The information processor of the present invention may be arranged so that
the controller is configured to hide the display-use remaining number of game plays of the second game when the display-use remaining number of game plays of the second game becomes zero as a result of execution of the second game.

According to this, “zero” is not displayed as the remaining number of game plays of the second game, and thus the player is not notified that this is the last game play of the second game. This prevents the player from predicting whether the second game state continues, and can cause the player to expect that the second game state continues.

The information processor of the present invention may be arranged so that,
when the display-use remaining number of game plays of the second game becomes zero as a result of the execution of the second game, the controller displays a sign indicating a possibility, in which the second game state continues, in an area in which the display-use remaining number of game plays of the second game was displayed.

According to this, when “zero” should be displayed as the remaining number of game plays of the second game, the sign indicating the possibility in which the second game state continues is displayed. This makes it possible to cause the player to clearly expect that the second game state continues.

A game control method of the present invention includes:
a process of switching, depending on a predetermined condition, a game state between (i) a first game state in which a first game which requires a bet is executed and (ii) a second game state in which a second game which does not require the bet is executed, the game state including the first game state and the second game state;
a process of displaying how the first game and the second game progress on a display;
a process of determining the number of execution times of the second game in the second game state;
when the second game is executed an initial predetermined number of times in the second game state, a process of setting the display-use remaining number of game plays of the second game to a value obtained by subtracting one from an initial value each time the second game is executed, the initial value being set to be smaller than the number of execution times of the second game, the display-use remaining number of game plays of the second game being displayed on the display as the remaining number of game plays of the second game; and
a process of setting the actual remaining number of game plays of the second game as the display-use remaining number of game plays of the second game when the second game is executed after the second game has been executed the initial predetermined number of times.

According to this, the remaining number of game plays of the second game in the second game state is not displayed as it is, and a value smaller than the actual remaining number of game plays of the second game is displayed and counted down as the initial predetermined number of times of the second game. With this arrangement, there is no need to display the maximum remaining number of awarded game plays of the second game. This makes it possible to reduce resources such as an image which is not displayed and to prevent the player from predicting whether the second game state in which the second game is executed continues.

A game control method of the present invention includes:
a process of switching, depending on a predetermined condition, a game state between (i) a first game state in which a first game which requires a bet is executed and (ii) a second game state in which a second game which does not require the bet is executed, the game state including the first game state and the second game state;
a process of displaying how the first game and the second game progress on a display;
a process of determining the number of execution times of the second game in the second game state; and
a process of executing the second game the number of all the execution times in the second game state while a value smaller than the number of the execution times of the second game is repeatedly counted down.

According to this, the remaining number of game plays of the second game in the second game state is not displayed as it is, but displayed so that a countdown of a small value is repeated. With this arrangement, there is no need to display the maximum remaining number of awarded game plays of the second game. This makes it possible to reduce resources such as an image which is not displayed and to prevent the player from predicting whether the second game state in which the second game is executed continues.

### BRIEF DESCRIPTION OF THE DRAWINGS

FIG. 1 illustrates the schematic structure of an information processor in terms of displaying.

FIG. 2 illustrates displaying of the remaining number of game plays of a second game.

FIG. 3 is a block diagram of the electrical configuration of the information processor.

FIG. 4 is a flowchart of a game control process.

FIG. 5 is a flowchart of a second game state execution process.

FIG. 6 is a flowchart of a second game play count random determination process (a process of randomly determining the number of game plays of a second game).

FIG. 7 is a flowchart of a remaining game play count display setting process (a process of setting the remaining number of game plays of the game for displaying).

FIG. 8 illustrates explanatory images on a display.

### DETAILED DESCRIPTION OF THE PREFERRED EMBODIMENT

The following will describe a game system of the present invention with reference to figures.

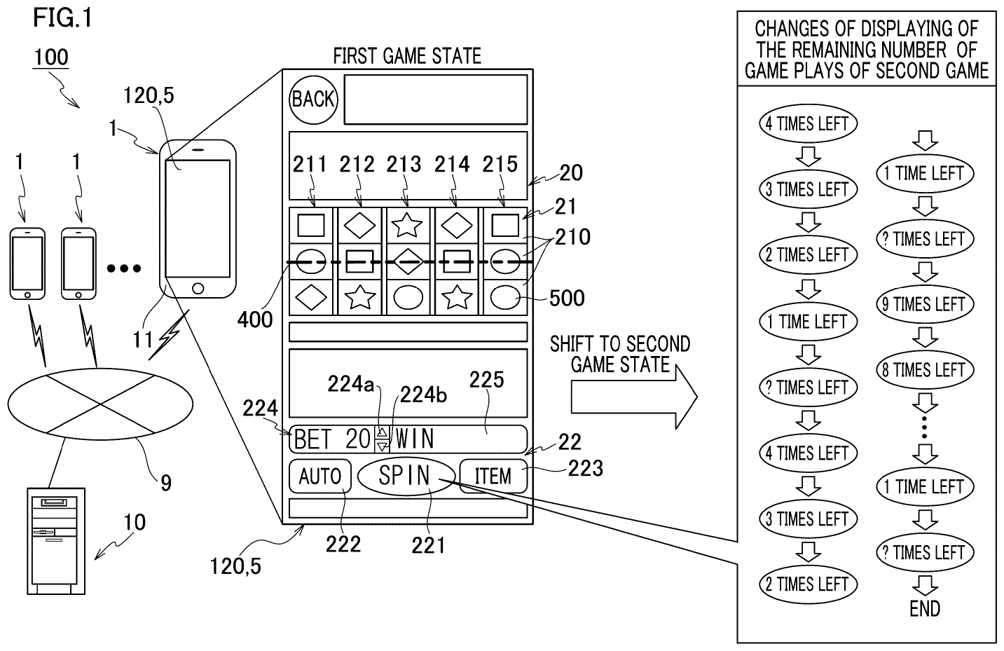

As shown in FIG. 1, a game state includes a first game state in which a first game which requires a bet is executed and a second game state in which a second game which does not require a bet is executed, and the game state of the information processor 1 is switched between the first game state and the second game state depending on a predetermined condition. A display 120 is configured to display how the first game and the second game progress. When the game state is switched to the second game state, (i) the second game which does not require a bet is executable in the second game state and (ii) the number of execution times of the second game is determined each time the game state is switched to the second game state.

The first game includes a normal game, and the first game state includes a normal state. The second game includes a free game, and the second game state includes a special state.

In the present embodiment, the switching of the game state is performed as described below. In this regard, the first game state in which the first game requiring a bet is executed is the normal state. When the first game is executed for the first time, the maximum number of game plays (e.g., 1200 game plays, 1500 game plays, or 1800 game plays) of the first game in the first game state is randomly determined (i.e., a so-called “pity system” is set). When the first game has been executed the maximum number of times in the first game state, the game state is shifted from the first game state to the second game state.

In the present embodiment, whether the shift to the second game state occurs is randomly determined in the first game state each time the first game is executed. When the shift to the second game state is won, the game state is shifted to the second game state after the first game is executed a predetermined number of times (e.g., four times) after this winning. As such, the game is executed a predetermined number of times during one period after the winning, and this period will be referred to as a continuous state. Furthermore, this random determination will be referred to as continuous state random determination.

In the present embodiment, depending on symbols rearranged in the first game, the game state is shifted to another special state which is not the second game state. In the present embodiment, this special state will be referred to as a third game state. In the third game state, a third game which does not require a bet is executable. As the shift to the third game state is determined (fixed), whether the shift to the second game state occurs is randomly determined. When the shift to the second game state is won, the game state is shifted to the second game state after the third game state ends.

As such, a shifting condition to the second game state includes executing the first game the maximum number of times in the first game state. A shifting condition to the second game state includes achieving a winning in the continuous state random determination in the first game state and executing the first game a predetermined number of times after this winning. A shifting condition to the second game state includes achieving a winning in random determination on the premise that the shift to the third game state is determined (fixed).

In the second game state, the display-use remaining number of game plays of the game is displayed on a spin button 221 (described later). The display-use remaining number of game plays of the game is determined based on the actual remaining number of game plays of the second game. When the second game is executed the initial predetermined number of times in the second game state, the display-use remaining number of game plays of the game is set to a value obtained by subtracting one from an initial value each time the second game is executed. This initial value is set to be smaller than the number of execution times of the game. In the example of FIG. 1, the number of execution times of the second game in the second game state is 20, and the remaining number of game plays of the second game which is smaller than the actual remaining number of game plays of the second game is displayed and counted down in the first ten game plays (i.e., the initial predetermined number of times of the game).

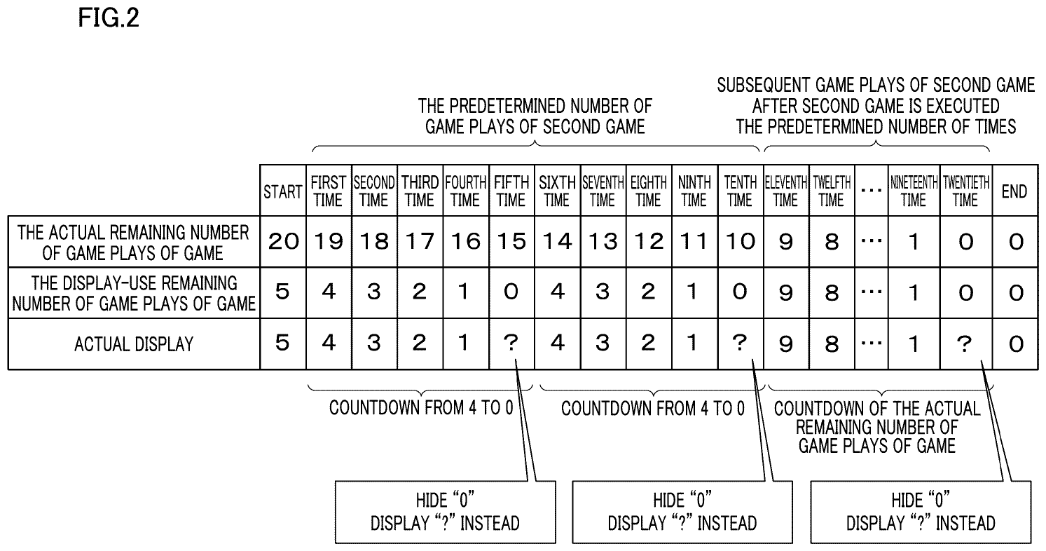

The following will describe the remaining number of game plays of the second game displayed on the spin button 221, with reference to FIG. 2. In the example of FIG. 2, the second game is executed 20 times in the second game state. When the second game is executed 20 times, the initial predetermined number of times of the game is the first ten game plays. As shown in FIG. 2, when the game is executed the initial predetermined number of times, a countdown on the spin button 221 is different from an actual countdown. In the example of FIG. 2, when the second game is executed the initial predetermined number of times (10 times), a countdown from the initial value is performed twice. As such, the display-use remaining number of game plays of the game is managed based on the actual remaining number of game plays of the game.

When the display-use remaining number of game plays of the game is “zero”, a numeral value of this remaining number of game plays of the game is hidden. Instead of the numeral value, a sign indicating a possibility in which the second game state continues is displayed. In the present embodiment, this sign is “? (question mark)”. However, the disclosure is not limited to this. When the second game has not been executed the initial predetermined number of times even after a countdown ends, an initial value is set again as the display-use remaining number of game plays of the second game. This initial value which is set each time the countdown ends may be a different value.

As such, the remaining number of game plays of the second game in the second game state is not displayed as it is, and a value smaller than the actual remaining number of game plays of the second game is displayed and counted down as the initial predetermined number of times of the second game. With this arrangement, there is no need to display the maximum (actual) remaining number of awarded game plays of the second game. This makes it possible to reduce resources such as an image which is not displayed and to prevent the player from predicting whether the second game state in which the second game is executed continues.

As described above, when the second game is executed after the second game has been executed the initial predetermined number of times in the second game state, the actual remaining number of game plays of the second game is set as the display-use remaining number of game plays of the game. In the example of FIG. 2, when the last ten game plays of the second game are being executed (when the second game is executed after the second game has been executed the initial predetermined number of times), the actual remaining number of game plays of the game is displayed. Similarly to the initial predetermined number of times of the game, when the display-use remaining number of game plays of the game is “zero”, a numeral value of the remaining number of game plays of the game is hidden. Instead of the numeral value, the sign “?” indicating a possibility in which the second game state continues is displayed. This sign may be a different sign as long as it does not show the remaining number of game plays of the game and it indicates that the game state continues.

As such, when the remaining number of game plays of the second game is counted down, “zero” should be displayed, but is hidden. With this arrangement, “zero” is not displayed as the remaining number of game plays of the second game, and thus the player is not notified that this is the last game play of the second game. This prevents the player predicting whether the second game state continues, and can cause the player to expect that the second game state continues.

Instead of displaying “zero”, the sign “? (question mark)” is displayed to indicate a possibility in which the second game state continues. As such, when “zero” should be displayed as the remaining number of game plays of the game, a sign indicating a possibility in which the second game state continues is displayed. This makes it possible to cause the player to clearly expect that the second game state continues.

As such, in the second game state, the second game is executed the number of all execution times while a countdown of a value smaller than the actual number of execution times is repeated. The remaining number of game plays of the second game in the second game state is not displayed as it is, but displayed so that a countdown of a small value is repeated. With this arrangement, there is no need to display the maximum remaining number of awarded game plays of the second game. This makes it possible to reduce resources such as an image which is not displayed and to prevent the player from predicting whether the second game state in which the second game is executed continues.

The information processor 1 is connected to a server 10 via the Internet 9 so that (i) data communication is possible and (ii) a game system 100 including the information processor 1 and the server 10 is constituted. The game system 100 is not limited to this, and may be constituted only by the information processor 1. The information processor 1 may indicate a game system itself which includes a terminal device such as a smartphone and the server 10, and functions of the information processor 1 of the present embodiment may be performed by any component of the game system 100.

The following description may presuppose that a user has logged in the server 10 via the information processor 1. For example, the user inputs a user ID and a password in the information processor 1, and log-in of the user is authenticated by the server 10 through a communication line. The information processor 1 may be configured to store log-in information for this log-in authentication and, at activation of a game by the user, to allow the user to automatically log in the server 10 without an input of information by using of the stored log-in information. Alternatively, the information processor 1 may be configured to allow the user to automatically log in the server 10 without an input of information by using biometrics authentication of the user at the activation of the game by the user. In this regard, known ones such as face, fingerprint, retina, iris, vein patterns, voiceprint, and the like can be used as biometric information used for the biometrics authentication. As such, the server 10 is configured to allow the user to log in each information processor 1 and to execute the game.

In each of information processors 1, shared application software is installed from an application software server, etc. in accordance with the OS (Operating System) of each information processor 1. In the present embodiment, a slot game is playable as a game element of the application software installed in the information processor 1. That is, the user can play the slot game on this application software. This slot game may be an add-in of the application software. That is, the slot game may be independent from the application software and may be provided by an application software server, a server 10, etc. as an additional function of the application software. The application software may allow the player to play plural types of slot games which are different in effects or rules.

As detailed later, a slot game starts on the premise that an accumulable gaming value is consumed (betted). When a winning is achieved as a result of the slot game, a gaming value corresponding to the type of the winning and the consumed gaming value is added to the accumulated gaming value as a reward. As such, the information processor 1 is configured to execute the slot game in which an accumulable gaming value is increased or decreased in accordance with a result. The gaming value may be information (game point) which is used exclusively for starting the slot game and which does not have a monetary value or may be electronic valuable information having a monetary value.

As shown in FIG. 1, the information processor 1 of the present embodiment is a so-called smartphone, and includes a display 120 provided on a front surface of a housing 11 and a touch panel 5 provided throughout the display 120. The information processor 1 is not limited to this, and may be a mobile or desktop device. Examples of the information processor 1 include a mobile information device such as a portable computer, a laptop computer, a tablet PC, a handheld PC, and a PDA (Personal Data Assistant).

The display 120 is able to display images. Examples of a display method of the display 120 include liquid crystal, organic electroluminescence, CRT (Cathode Ray Tube), and plasma.

The touch panel 5 is able to detect the coordinates of its part touched by a user's finger, etc. The touch panel 5 adopts a known technology such as electromagnetic induction and electrostatic capacity. The information processor 1 is configured to determine an object on a screen touched by the user or the state of touching such as swipe, etc. based on the coordinates detected by the touch panel 5, and to make a response in accordance with a result of this determination.

In the present embodiment, the touch panel 5 is configured to operate as an input device and to receive a swipe input, a touch input, etc. However, the present embodiment is not limited to this. For example, the input device may be a microphone or a camera. The input device may be configured to receive the voice or gesture of the user as an instruction input.

The touch panel 5 may not be provided on the front surface of the display 120. For example, the touch panel 5 may be provided on the rear side of the housing 11 so as to be opposite to the display 120. Alternatively, the touch panel 5 may be provided at a part of the display 120.

The display 120 is configured to display a slot game screen 20. The slot game screen 20 is provided with a symbol display area 21 where symbols 500 are varied and stopped as the game (first game or second game) starts. The symbol display area 21 is provided with a first scroll area 211, a second scroll area 212, a third scroll area 213, a fourth scroll area 214, and a fifth scroll area 215. Each of the scroll areas 211 to 215 is provided with three cells 210 which are aligned in the up-down direction so as to form an upper stage, a middle stage, and a lower stage. That is, fifteen cells 210 are arranged to form a matrix of five columns by three rows in the symbol display area 21. Each cell 210 is a setting area defining a stop position of a symbol, and may be displayed or hidden. A single symbol 500 is arrangeable for each cell 210. That is, when the symbols 500 are rearranged, fifteen symbols 500 are arranged in total so as to form a matrix of five columns by three rows. The number of the cells 210 in the symbol display area 21 is not limited to this.

As shown in an example of FIG. 1, winning determination lines 400 are set in the symbol display area 21. Each winning determination line 400 is formed of five cells 210 selected from the respective scroll areas 211 to 215. The winning determination is performed before the symbols 500 are rearranged, and a winning result is shown to the user as the symbols 500 are rearranged.

To be more specific, the winning determination line 400 is formed of five cells 210, i.e., one cell 210 included in the first scroll area 211, one cell 210 included in the second scroll area 212, one cell 210 included in the third scroll area 213, one cell 210 included in the fourth scroll area 214, and one cell 210 included in the fifth scroll area 215. Hereinafter, the winning determination line 400 may be referred to as a winning line or a payline. In the winning determination line 400, the above-described five cells 210 are arranged in order from the cell 210 of the first scroll area 211 to that of the fifth scroll area 215. That is, in the winning determination line 400, the cell 210 of the first scroll area 211 is next to that of the second scroll area 212, that of the second scroll area 212 is next to that of the third scroll area 213, that of the third scroll area 213 is next to that of the fourth scroll area 214, and that of the fourth scroll area 214 is next to that of the fifth scroll area 215. This arrangement order of the five cells 210 is also used when the symbols 500 are stopped in the scroll areas 211 to 215. That is, scrolling of the symbols 500 is stopped in order from a symbol 500 of the first scroll area 211 to a symbol 500 of the fifth scroll area 215.

A lower part of the slot game screen 20 is provided with an operation area 22 for receiving an input which is made by the user to progress the game. An input which is made to the operation area 22 by the user is detected by the touch panel 5.

The operation area 22 includes a spin button 221, an automatic input portion 222, an item input portion 223, a bet portion 224, and a WIN display portion 225. The bet portion 224 includes a bet amount increase input portion 224a and a bet amount decrease input portion 224b. The bet amount increase input portion 224a is an area for receiving an input to increase a bet amount in a bet time. The bet amount decrease input portion 224b is an area for receiving an input to decrease a bet amount in the bet time. On the touch panel 5, an area where the bet portion 224 is displayed functions as a bet amount changing portion for changing a bet amount. The bet amount is, e.g., selected from numbers such as 1, 2, 3, 5, and 10 by operating the bet portion 224.

The spin button 221 is an area for fixing a bet amount received by the bet portion 224 so as to finish the bet time and receiving an input to start a game time. That is, as a touch input is made to the spin button 221, the symbols 500 start to be scrolled in the symbol display area 21. The automatic input portion 222 is an area for receiving an input to skip an input made to the spin button 221 in subsequent game plays. That is, as the automatic input portion 222 is operated, the subsequent game plays are automatically started. When the automatic input portion 222 is operated again in this automatic state, the automatic state is cancelled. The item input portion 223 is an area for receiving an input to use an item which is advantageous to the progress of the slot game. Although not illustrated, as the item input portion 223 is operated, another window in which the item is selectable is displayed. A credit amount awarded as a result of the slot game is displayed in the WIN display portion 225.

The winning determination is typically performed in a winning determination method referred to as a payline method. In the payline method, in any winning determination line 400, when (i) symbols 500 of the same type are successively rearranged in the above-described order from the first scroll area 211 and (ii) the number of these symbols 500 is a predetermined number or more, it is determined as a winning regarding this type of the symbols 500. In each of the first game and second game of the present embodiment, the winning determination is performed in the payline method. However, the disclosure is not limited to this. For example, the winning determination may be performed in a so-called “LEFT TO RIGHT” method.

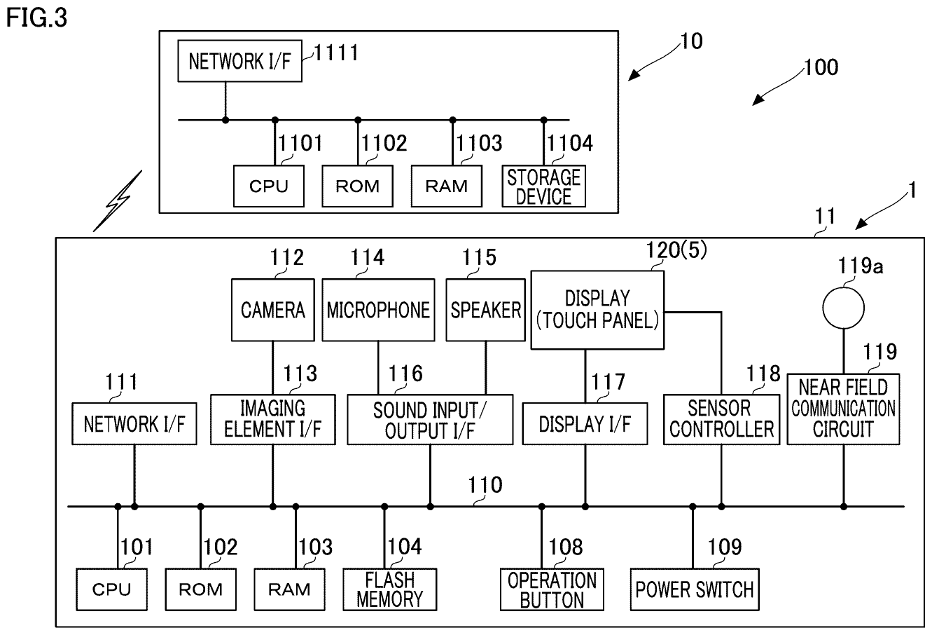

The following will describe the electric configuration of the game system 100 formed of the information processor 1 and the server 10, with reference to FIG. 3. As shown in FIG. 3, the information processor 1 includes, in the housing 11, a CPU 101, a ROM 102, a RAM 103, a flash memory 104, an operation button 108, a power switch 109, a bus line 110, a network I/F 111, a camera 112, an imaging element I/F 113, a microphone 114, a speaker 115, a sound input/output I/F 116, a display I/F 117, a sensor controller 118, a near field communication circuit 119, and an antenna 119a of the near field communication circuit 119.

The server 10 is a so-called computer including a CPU 1101, a ROM 1102, a RAM 1103, a storage device 1104 such as a hard disk drive, etc., and a network I/F 1111.

The CPU (Central Processing Unit) 101 functions as a main feature of a controller in the information processor 1, and is configured to control the entire operation of the information processor 1. The CPU 1101 functions as a main structure of a controller in the server 10, and is configured to control the entire operation of the server 10. The CPUs 101 and 1101 therefore function as controllers which control the entire operation of the game system 100. The ROM (Read Only Memory) 102 stores programs used for driving the CPU 101, such as an IPL (Initial Program Loader).

The RAM (Random Access Memory) 103 and the RAM 1103 are used as a work area of the CPU 101 and the CPU 1101. The operation button 108 is used for, e.g., initial setting of the information processor 1. The power switch 109 is used for turning on/off the power source of the information processor 1.

The flash memory 104 functioning as a memory is a non-volatile computer readable medium which stores a game program, a program for communication, and data such as image data and sound data. The storage device 1104 is a non-transitory computer readable medium which functions as a database and which stores game data of each information processor 1. The server 10 is configured to return as needed a response referring to the database of the storage device 1104 in response to a request from the game program of the information processor 1.

For example, the flash memory 104 stores various programs which include the game program executed by the CPU 101 functioning as a controller and various data used in the various programs. To put it differently, the game program causes the information processor 1 including the CPU 101 and the flash memory 104 to execute processes of programs. For example, when the information processor 1 is equivalent to the game system 100, the flash memory 104 (storage device 1104) stores various programs including the game program executed by the CPU 101 (CPU 1101) functioning as the controller and various data used in the various programs. In other words, this game program causes the information processor 1 which is the game system 100 including the CPU 101, the CPU 1101, the flash memory 104, and the storage device 1104 to execute processes of these various programs. As such, the processes and operation of the information processor 1 can be interpreted as those of a program or a game control method.

The data and program stored in the flash memory 104 and the storage device 1104 may be stored in advance at the stage of factory shipment, or may be downloaded from an unillustrated server, etc. via communication means and then stored. The communication means may be an interactive communication passage such as the Internet and a cable TV, or may be one-way broadcasting. Alternatively, the data and program stored in the flash memory 104 and the storage device 1104 may be stored in a recording medium such as a floppy disk, a CD-ROM, a DVD-ROM, an MO (optical magnetic disk), and a flash memory and may be read from the recording medium and installed according to need.

Each of the network I/F (Interface) 111 and the network I/F 1111 is an interface provided for data communication using a communication network such as the Internet. The camera 112 is a built-in camera image capturing means for capturing an image of an object so as to obtain image data under the control of the CPU 101. The imaging element I/F 113 is a circuit for controlling the camera 112. The microphone 114 is a built-in sound collection means to which sound is input. The sound input/output I/F 116 is a circuit for processing the input and output of a sound signal between the microphone 114 and the speaker 115 under the control of the CPU 101. The display I/F 117 is a circuit for sending image data to the display 120 under the control of the CPU 101. The display 120 is provided on the front surface of the housing 11. The sensor controller 118 is a circuit for receiving an input from the touch panel 5 of the display 120. The near field communication circuit 119 is a communication circuit based on NFC (Near Field Communication) (Registered Trademark), Bluetooth (Registered Trademark), etc. The bus line 110 is an address bus, a data bus, etc. provided for electrically connecting the components such as the CPU 101.

As shown in FIG. 3, the game system 100 includes the information processor 1 and the server 10 each of which is a computer, the display 120, the memory (ROM 102, RAM 103, flash memory 104, ROM 1102, RAM 1103, storage device 1104, etc.), the controller (CPU 101, CPU 1101, etc.), and the touch panel 5.

The display 120 and the touch panel 5 are provided in the information processor 1, and function as an output device and an input device in the game system 100 respectively.

The memory stores various programs including the game program executed by the controller and various data used in the various programs. The memory is a conceptual storage area in the game system 100, which may be implemented either in the information processor 1 or in the server 10. Alternatively, the function of the memory may be separately implemented in the information processor 1 and the server 10, or the function of the memory may be implemented both in the information processor 1 and the server 10. That is, in the game program executed in the information processor 1, when data stored in the server 10 is necessary, the information processor 1 requests the data to the server 10 and the server 10 responds to such a request of data.

The controller functioning as a control unit is configured to execute various types of processes according to the game program stored in the memory. The controller is a conceptual execution device in the game system 100, which may be implemented either in the information processor 1 or in the server 10. Alternatively, the function of the controller may be separately implemented in the information processor 1 and the server 10, or the function of the controller may be implemented both in the information processor 1 and the server 10.

As such, the game system 100 functions as a single computer including (i) the information processor 1 functioning as the input device (touch panel 5) and the output device (display 120) and (ii) the information processor 1 and/or the server 10 functioning as the memory and the controller.

The controller is programmed to execute the processes below. In other words, the game program stored in the memory causes the game system 100 functioning as the computer to execute the processes (A1 to A4 (A4a and A4b)) below. To be more specific, the controller is configured to execute: a process (A1) of switching the game state between the first game state and the second game state; a process of (A2) displaying how the first game and the second game progress; a process (A3) of determining the number of execution times of the second game; and a process (A4) of executing the second game the number of all execution times while (i) the second game is executed the initial predetermined number of times in the second game state and (ii) a value smaller than the number of execution times is repeatedly counted down as the remaining number of game plays of the second game. To be more specific, the following processes are executed in the process (A4): a process (A4a) of displaying a countdown of an initial value; and a process (A4b) of displaying the actual remaining number of game plays of the second game as the remaining number of game plays of the second game when the second game is executed after the second game has been executed the initial predetermined number of times in the second game state.

As such, instead of displaying the remaining number of game plays of the second game in the second game state as it is, an initial value smaller than the actual remaining number of game plays of the second game is displayed and counted down as the initial predetermined number of times of the second game. With this arrangement, there is no need to display the maximum remaining number of awarded game plays of the second game. This makes it possible to reduce resources such as an image which is not displayed and to prevent the player from predicting whether the second game state in which the second game is executed continues.

As the information processor 1 including the above-described program executes the processes (A1) to (A4), a game control method of executing the processes (A1) to (A4) by means of the information processor 1 (computer) is embodied. In other words, the information processor 1 includes plural processing units configured to execute the respective processes (A1) to (A4). While the following description deals with the information processor 1, the processes and operation of the information processor 1 can be interpreted as those of the game program or the game control method stored in a non-volatile storage medium. The processes executed by the controller may be executed only in the information processor 1, or may be executed by the game system 100 including the server 10. That is, the processes and operation of the information processor 1 may be interpreted as those of the game system 100.

The following will describe a typical slot game. The slot game is playable by the user as a game element of the installed application software. The slot game is a game in which (i) symbols 500 are varied and then stopped (rearranged) in the symbol display area 21 and (ii) a gaming value is awarded based on a combination of symbols 500 displayed in the symbol display area 21. A state in which symbols 500 are varied and then stopped in the symbol display area 21 is referred to as “rearrangement”. In the slot game, the second game which is advantageous for the player as compared to the first game may be executed when (i) the first game is executed and (ii) a predetermined condition is met in the first game.

A gaming value is consumed for executing the first game in the first game state, and can be awarded as a game result. That is, as the user plays the slot game (unit game) once by betting the gaming value, the user may acquire a benefit such as the gaming value, etc. as a result of the slot game. As described above, the gaming value may be a game point which is used as a substitute for a credit in a game and which does not include valuable information or may be a coin, a banknote, or electrically valuable information equivalent to the coin or the banknote. Hereinafter, each gaming value may be referred to as a credit. The number of gaming values used for a bet may be referred to as a bet amount.

The “unit game” is a series of operations from the start of receiving of a bet to the establishment of a prize (i.e., to the state in which a symbol combination satisfies a predetermined relation). That is, the unit game includes a single bet time of receiving a bet, a single game time of rearranging symbols, and a single payout time of performing a payout process of awarding a payout when the prize is established. When the prize is not established, the unit game does not include the payout time because there is no payout.

The gaming value is used as a substitute for a credit in the game, and used for executing the slot game. That is, as the user plays the slot game (unit game) once by betting the gaming value, the user may acquire the gaming value as a result of the slot game.

The second game state includes one or more game plays of the second game. The second game is a game in which a payout is larger than that in the first game. Typically, the second game is arranged so that a symbol combination is easily established as compared to the first game. With this arrangement, a large payout is highly possibly awarded to the user in the second game as compared to the first game. The second game is executable with a small gaming value as compared to the first game. In this regard, “executable with a small gaming value” encompasses a bet of zero gaming value. Therefore, the second game may be a game which is executed without a bet of a gaming value and which awards a gaming value based on rearranged symbols. In other words, the second game may be a game started without the consumption of a gaming value. Meanwhile, the first game is a game which is executed with a bet of a gaming value and which awards a gaming value based on rearranged symbols. In other words, the first game is a game started with the consumption of a gaming value. Similarly to the second game state, the third game state is also advantageous as compared to the first game state.

The slot game may be arranged as described below.

For example, the slot game may be arranged so as to change the number of game plays of the second game based on the type of won trigger symbols in the first game after the shift to the second game state. To be more specific, a random determination table based on which the number of game plays of the second game is randomly determined may be different between a case where three trigger symbols of the same type are rearranged among trigger symbols of plural types and a case where three trigger symbols of different types are rearranged among trigger symbols of plural types. That is, when three trigger symbols of the same type are selected, the random determination table may be advantageous as compared to the case where three trigger symbols of different types are rearranged. For example, the word “advantageous” indicates the following cases: a case where the probability distribution of the random determination table is set so that the large number of game plays of the second game is easily won; and a case where the random determination table includes the larger number of game plays of the second game as a target of random determination. The same may apply to the third game state.

In the present embodiment, processes and operations are described on the premise that the information processor 1 which is a smartphone has the above-described functions. However, these functions may be distributed to the components of the game system 100. For example, random determination of a result of the slot game may be performed by the server 10. That is, the information processor 1 may be formed of the game system 100.

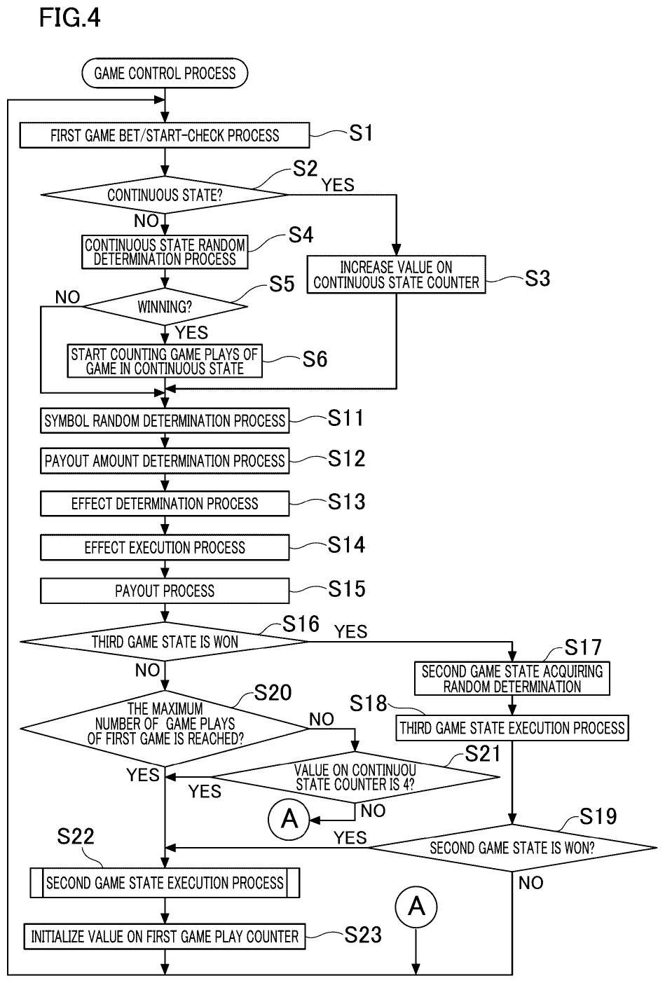

The following will describe a game control process executed by the CPU 101 of the information processor 1, with reference to FIG. 4.

Although not illustrated, plural types of games are executable on the application software of the information processor 1. For example, when a game of one type is activated, a first game play counter (described later), a continuous state counter (described later), etc. may be read from saved data. Such reading from the saved data may be performed at the time of activation on the premise that another type of a game is not executed after one type of a game ends. The game in the first game state is started.

To begin with, the CPU 101 executes a bet/start-check process of the first game (S1). In this bet/start-check process, a credit amount (the number of coins) to be betted is determined by a touch input made to the display 120 of the information processor 1. Subsequently, the credit amount is betted and stored in a bet counter of the RAM 103. When a bet has been made, the betted credit amount is subtracted from a value on a coin counter provided at the RAM 103. The credit amount has been betted and determined as described above. A payout of a winning is calculated by multiplying this credit amount by a payout amount corresponding to the number (three to five) of symbols of the same type which are rearranged (displayed) in the symbol display area 21 as a result of the slot game. In the bet/start-check process, the CPU 101 determines whether a touch input has been made to the spin button 221. When it is determined that the touch input has been made to the spin button, the shift to the step S11 occurs to progress the slot game.

Subsequently, the CPU 101 determines whether the continuous state is won in the first game state (S2). When it is determined that the continuous state is won (YES in S2), the CPU 101 increases a value on the continuous state counter (S3). The continuous state counter is provided for counting the number of execution times of the first game in the continuous state. As the value on the continuous state counter reaches a predetermined number (four in the present embodiment), the shift from the first game state to the second game state occurs.

When it is determined that the continuous state is not won (NO in S2), the CPU 101 performs a continuous state random determination process (S4). That is, after the first game has been executed predetermined times, the CPU 101 determines whether the shift to the second game state occurs. Subsequently, the CPU 101 determines whether a winning has been achieved in the continuous state random determination (S5). When it is determined that the winning has been achieved (YES in S5), the CPU 101 starts counting the number of execution times of the first game in the continuous state (S6).

Subsequently, the CPU 101 executes a symbol random determination process (S11). In this process, to-be-stopped symbols are randomly determined from among symbols arranged in the five scroll areas 211 to 215 (see FIG. 1). These to-be-stopped symbols are symbol data of fifteen symbols which are to be displayed in the symbol display area 21. In this way, fifteen symbols which are to be displayed in the symbol display area 21 are determined.

The CPU 101 then stores these fifteen determined to-be-stopped symbols in a symbol storing area provided in the RAM 103.

Subsequently, the CPU 101 performs a payout amount determination process based on a result of the symbol random determination process (S12). In this process, the CPU 101 determines the number of symbols of each type which are to be rearranged (displayed) in the symbol display area 21. When the number of to-be-rearranged symbols of each type on a payline is a predetermined number or more (three to five), the CPU 101 uses a paytable stored in the RAM 103 and determines a payout amount (payout value) corresponding to the number of these to-be-rearranged symbols of each type. When the number of the to-be-rearranged symbols of any type is not the predetermined number or more, a payout amount is nothing (i.e., a payout value is zero). The determined payout amount (payout) is stored in a payout amount storage area provided in the RAM 103.

The CPU 101 then executes an effect determination process (S13). The CPU 101 samples an effect-use random number, and randomly selects any of a plurality of predetermined effect contents. For example, the CPU 101 determines to use an effect of scrolling the scroll areas 211 to 215 in the symbol display area 21 and stopping and displaying the fifteen symbols having been determined in the symbol random determination process of the step S21. To be more specific, for example, when a trigger symbol is won as one to-be-stopped symbol, the CPU 101 may determine the performance of an indication effect of indicating, during scrolling of symbols, the rearrangement of the trigger symbol for the symbol display area 21 where the trigger symbol is to be stopped. For another example, the CPU 101 determines to use an effect of highlighting symbols regarding a winning among the stopped symbols, an effect of displaying a payout in the WIN display portion, a special WIN effect used when the payout is equal to or more than a predetermined multiple of a bet amount, etc.

The CPU 101 then performs the determined effect content at a determined time (S14). For example, the CPU 101 displays an effect image in the display 120 and outputs sound by means of the speaker 115. For another example, the CPU 101 displays an image in which (i) symbols are scrolled on the reels in the symbol display area 21 and then (ii) to-be-stopped symbols are stopped. For another example, the CPU 101 displays an image in which symbols regarding a winning are highlighted among stopped symbols and performs an effect of incrementing an owned credit amount. For another example, the CPU 101 performs an effect of shifting to the above-described second game state. As a result of the game, when there is a credit amount to be added, the CPU 101 executes the payout process of adding this credit amount to the owned credit amount (S15). The payout process may be performed at a predetermined time in the effect execution process of the step S24 (e.g., at a time when the owned credit amount is incremented). The CPU 101 then terminates this sub routine. At this time, for example, the CPU 101 may clear data which is stored in the working area of the RAM 103 and which becomes unnecessary at the end of each unit game. Examples of this data include data in the executed unit game such as (i) a value on a bet counter of a bet amount storage area and (ii) symbols which are randomly determined to be displayed in the symbol display area 21.

Subsequently, the CPU 101 determines whether three or more trigger symbols has been won in the symbol random determination process of the step S11 so as to meet a shifting condition to the third game state (S16). For example, the shifting condition to the third game state is that three or more trigger symbols are won in the symbol random determination of the first game so as to trigger the third game state. When it is determined that the shifting condition to the third game state has been met (YES in S16), the CPU 101 performs second game state acquiring random determination (S17). The CPU 101 then performs a third game state execution process (S18). The CPU 101 executes the third game, which does not require a bet, a predetermined number of times in the third game state execution process. Subsequently, the CPU 101 determines whether a winning has been achieved in the second game state acquiring random determination of the step S17 (S19). When it is determined that the winning has been achieved in the second game state acquiring random determination, the game state is shifted from the third game state to the second game state after the end of the third game state.

When it is determined that the shifting condition to the third game state is not met (NO in S16), the CPU 101 determines whether a value on the first game play counter has reached the maximum number of game plays (e.g., 1200, 1500, or 1800 game plays randomly determined in advance) of the first game (S20). The first game play counter is provided for counting the number of execution times of the first game in the first game state. Although not illustrated, the CPU 101 increases the value on the first game play counter by one each time the first game is executed. When it is determined that the value on the first game play counter does not reach the maximum number of game plays of the first game (NO in S20), the CPU 101 determines whether the value on the continuous state counter has reached four (a predetermined number; S21).

When it is determined that the shift to the second game state has been won in the third game state (YES in S19), the CPU 101 performs a second game state execution process (S22). When it is determined that the value on the first game play counter has reached the maximum number of game plays of the first game (YES in S20), the CPU 101 performs the second game state execution process (S22). When it is determined that the value on the continuous state counter has reached four (YES in S21), the CPU 101 performs the second game state execution process (S22). After the performance of the second game state execution process, the CPU 101 initializes the first game play counter (S23) and causes the shift to the step S1. Although not illustrated, when the first game play counter is initialized in the step S23, the CPU 101 may performs a process of randomly determining the maximum number of game plays of the first game.

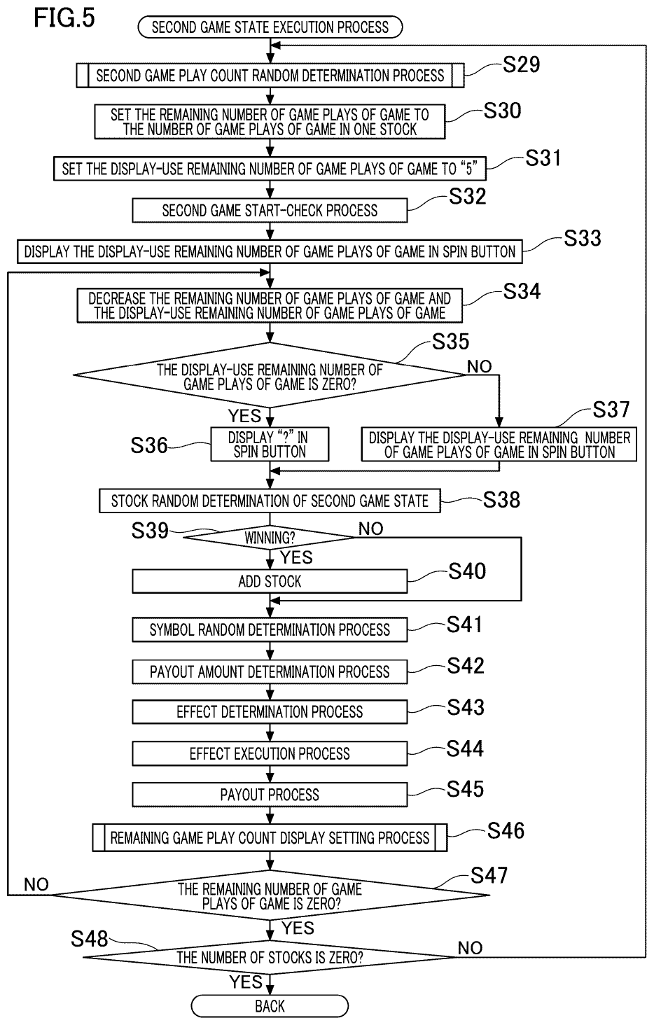

The following will describe the second game state execution process executed by the CPU 101 of the information processor 1, with reference to FIG. 5.

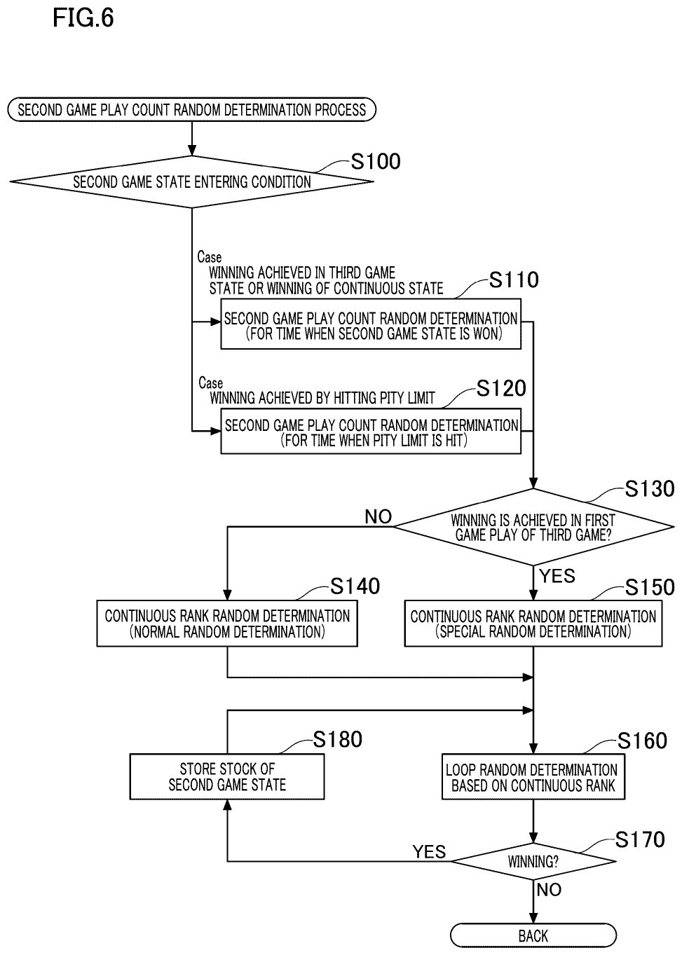

To begin with, the CPU 101 performs a second game play count random determination process (S29). The second game play count random determination process is described later with reference to FIG. 6. The CPU 101 then sets the remaining number of game plays of the game to the number of game plays of the game in one stock (S30). Each stock indicates the number of execution times of the second game in the second game state. For example, when there are plural stocks, each stock has the set number of execution times of the second game. In the step S30, one stock has the set number of game plays of the second game, and this set number of game plays of the second game is set as the remaining number of game plays of the second game in the second game state. Although not illustrated, for example, this stock is deleted in the step S30.

Subsequently, the CPU 101 sets the spin button 221 to “5” as the display-use remaining number of game plays of the game (S31). As such, regardless of the number of game plays of the second game, the same number is displayed at first in the second game state.

Subsequently, the CPU 101 performs a start-check process (S32). In this start-check process, the CPU 101 determines whether a touch input has been made to the spin button. When it is determined that the touch input has been made to the spin button, the CPU 101 starts progressing the slot game. The CPU 101 then displays the display-use remaining number of game plays of the game in the spin button 221 (see FIG. 1; S33). This display-use remaining number of game plays of the game has been set in the step S31.

Subsequently, the CPU 101 decreases both the remaining number of game plays of the game and the display-use remaining number of the game plays of the game (S34). The CPU 101 then determines whether the display-use remaining number of game plays of the game is zero (S35). When it is determined that the display-use remaining number of game plays of the game is zero (YES in S35), the CPU 101 displays “? (question mark)” in the spin button 221 (S36). When it is determined that the display-use remaining number of game plays of the game is not zero (NO in S35), the CPU 101 displays the display-use remaining number of game plays of the game in the spin button 221 (S37).

Subsequently, the CPU 101 performs stock random determination of the second game state (S38). When a winning has been achieved as a result of the stock random determination (YES in S39), a stock is added (S40).

Subsequently, the CPU 101 performs the symbol random determination process (S41) and the payout amount determination process (S42) in the same manner as the steps S11 and S12 of the game control process (see FIG. 4). The random determination table for the symbol random determination may be different from that in the step S11. In the symbol random determination process of the step S38, when a to-be-replaced symbol is arranged, a symbol by which each to-be-replaced symbol is replaced is randomly determined. For example, each to-be-replaced symbol may be replaced by a wild symbol with a multiplying factor and the multiplying factor may be randomly determined.

The CPU 101 then executes the effect determination process (S43). The CPU 101 samples an effect-use random number, randomly determines any of a plurality of predetermined effect contents, and executes the determined effect content at the determined time (S44).

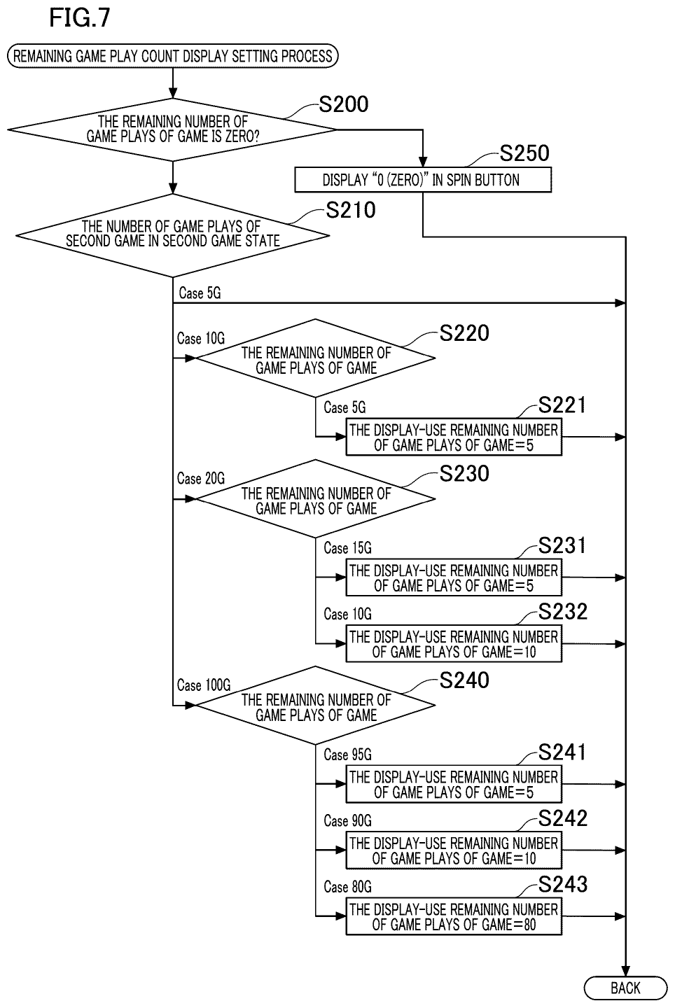

Subsequently, the CPU 101 executes the payout process (S45) in the same manner as the step S21 of the game control process (see FIG. 6). The CPU 101 then executes a remaining game play count display setting process (S46). The remaining game play count display setting process is described later with reference to FIG. 7. Subsequently, the CPU 101 determines whether the remaining number of game plays of the game is zero (S46). When it is determined that the remaining number of game plays of the game is not zero (NO in S46), the CPU 101 causes the shift to the step S34 and executes the second game until the remaining number of game plays of the game becomes zero. When it is determined that the remaining number of game plays of the game is zero (YES in S46), the CPU 101 determines whether the number of stocks is zero (S47). When it is determined that the number of stocks is not zero (NO in S47), the CPU 101 causes the shift to the step S30 and executes the second game until the number of stocks of the second game in the second game state becomes zero. When it is determined that the number of stocks is zero (YES in S47), the CPU 101 terminates the routine.

The following will describe the second game play count random determination process executed by the CPU 101 of the information processor 1, with reference to FIG. 6.

To begin with, the CPU 101 determines a second game state entering condition (S100). When the second game state is won in the third game, or when the second game state is won by winning the continuous state in the first game state, the CPU 101 performs the second game play count random determination for the time when the second game state is won (S110). When the second game state is won by hitting the pity limit, the CPU 101 performs the second game play count random determination for the time when the pity limit is hit (S120). The steps S110 and S120 are random determination regarding the number of game plays of the second game with use of different random determination tables in which different probabilities are set. For example, the number of game plays of the second game is randomly determined from among 5, 10, 20, and 100.

After that, the CPU 101 determines whether the won second game state is a state won at the first game play of the third game (S130). When it is determined that the won second game state is not a state won at the first game play of the third game (NO in S130), the CPU 101 performs normal continuous rank random determination (S140). When it is determined that the won second game state is a state won at the first game play of the third game (YES in S130), the CPU 101 performs special continuous rank random determination (S150). The steps S140 and S150 are random determination regarding a continuous rank (described later) with use of different random determination tables in which different probabilities are set. The continuous rank is a random determination table used in the next step S170.

Subsequently, the CPU 101 performs loop random determination based on the continuous rank (S160). When a winning has been achieved in the loop random determination (YES in S170), the CPU 101 stores a stock of the second game state (S180) and performs the loop random determination of the step S160. As such, the CPU 101 keeps storing the second game state until a winning is not achieved in the loop random determination. When a winning is not achieved in the loop random determination (NO in S170), the CPU 101 terminates the routine. The continuous rank indicates a winning probability in the loop random determination. The higher the continuous rank is, the hither the winning probability is.

The following will describe the remaining game play count display setting process executed by the CPU 101 of the information processor 1, with reference to FIG. 7. In FIG. 7, the word “game” may be illustrated as “G”.

To begin with, the CPU 101 determines whether the remaining number of game plays of the game is zero (S200). When it is determined that the remaining number of game plays of the game is not zero (NO in S200), the CPU 101 determines the number of game plays of the second game in the second game state which has been set in the step S30 (S210).

When the number of game plays of the second game is five, the CPU 101 terminates the routine. When the number of game plays of the second game is ten, the CPU 101 further determines the remaining number of game plays of the game (S220). When the remaining number of game plays of the game is five, the CPU 101 sets the display-use remaining number of game plays of the game to five (S221). After setting the display-use remaining number of game plays of the game, the CPU 101 terminates the routine.

When the number of game plays of the second game is 20, the CPU 101 further determines the remaining number of game plays of the game (S230). When the remaining number of game plays of the game is 15, the CPU 101 sets the display-use remaining number of game plays of the game to five (S231). When the remaining number of game plays of the game is ten, the CPU 101 sets the display-use remaining number of game plays of the game to ten (S232). After setting the display-use remaining number of game plays of the game, the CPU 101 terminates the routine.

When the number of game plays of the second game is 100, the CPU 101 further determines the remaining number of game plays of the game (S240). When the remaining number of game plays of the game is 95, the CPU 101 sets the display-use remaining number of game plays of the game to five (S241). When the remaining number of game plays of the game is 90, the CPU 101 sets the display-use remaining number of game plays of the game to ten (S242). When the remaining number of game plays of the game is 80, the CPU 101 sets the display-use remaining number of game plays of the game to 80 (S243). After setting the display-use remaining number of game plays of the game, the CPU 101 sets the routine.

Meanwhile, when it is determined that the remaining number of game plays of the game is zero (YES in S200), the CPU 101 displays “0 (zero)” as the remaining number of game plays of the free game in the spin button 221 (S250) and terminates the routine.

As such, an initial value of the display-use remaining number of game plays of the game is set based on the actual number and remaining number of game plays of the game per stock in the second game state. In the example of FIG. 2, immediately after the fifth game play of the second game has been executed, the remaining number of game plays of the game is 15. In this case, the step S231 is executed so that the display-use remaining number of game plays of the game is set to the initial value “5”. After setting the display-use remaining number of game plays of the game to the initial value, the display-use remaining number of game plays of the game is decreased to “4” in the step S34 and displayed in the step S37. In this regard, the step S34 is described above with reference to FIG. 5. Because of this, when the sixth game play of the second game is being executed, “4” is displayed in the spin button 221 as the remaining number of game plays of the game.

In the example of FIG. 7, the number of game plays of the second game is a target of random determination and 5, 10, 20, or 100. However, the disclosure is not limited to this. When a displayed countdown is “0 (when the actual remaining number of game plays of the second game is 5)”, “5 (when the actual remaining number of game plays of the second game is 10)”, “10 (when the actual remaining number of game plays of the second game is 20)”, or “20 (when the actual remaining number of game plays of the second game is 100)”, this countdown is different from the actual remaining number of game plays of the game. However, the disclosure is not limited to this.

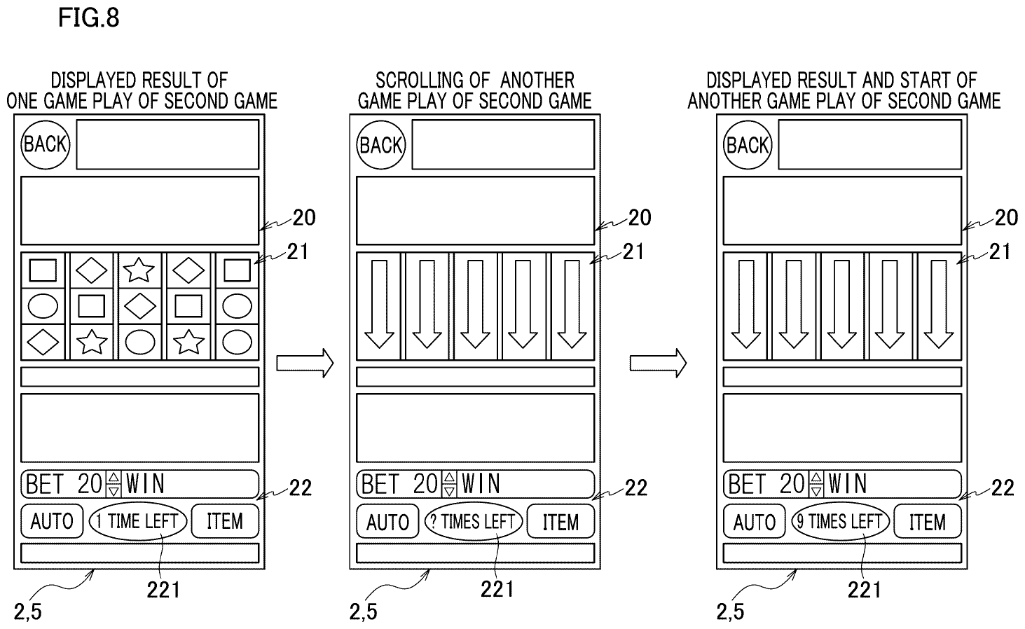

The following will describe an example of the slot game screen 20 displayed on the display 120, with reference to FIG. 8. For example, the following describes a case where (i) the preceding game play of the second game ends and (ii) the remaining number of game plays of the game becomes one. As the next game play of the second game starts and the symbol display area 21 starts scrolling, the display-use remaining number of game plays of the game internally becomes zero. Meanwhile, the sign “? (question mark)” is displayed on the spin button 221 instead of zero. In the example of FIG. 9, when the symbol display area 21 starts scrolling, displaying of the spin button 221 is updated. In the example of FIG. 9, when the next game play starts after the preceding game play in which the sign “? (question mark)” is displayed ends, “9” is displayed. This shows that the second game is additionally executable at least ten times. Although not illustrated, for example, when the remaining number of game plays of the second game is nothing, “0 (zero)” may be displayed in the spin button 221 while a result of the scrolling is shown.

Embodiments of the present invention thus described above solely serve as specific examples of the present invention, and are not to limit the scope of the present invention. The specific structures and the like are suitably modifiable. Further, the effects described in the embodiments of the present invention described in the above embodiment are no more than examples of preferable effects brought about by the present invention, and the effects of the present invention are not limited to those described hereinabove.

What is claimed is:

1. An information processor comprising: a controller configured to switch a game state, depending on a predetermined condition, between (i) a first game state in which a first game which requires a bet is executed and (ii) a second game state in which a second game which does not require the bet is executed, the game state including the first game state and the second game state; and
a display configured to display how the first game and the second game progress, and
the controller being configured to:
determine the number of execution times of the second game in the second game state;
when the second game is executed an initial predetermined number of times in the second game state, set the display-use remaining number of game plays of the second game to a value obtained by subtracting one from an initial value each time the second game is executed, the initial value being set to be smaller than the number of execution times of the second game, the display-use remaining number of game plays of the second game being displayed on the display as the remaining number of game plays of the second game; and
set the actual remaining number of game plays of the second game as the display-use remaining number of game plays of the second game when the second game is executed after the second game has been executed the initial predetermined number of times in the second game state.

2. The information processor according to claim 1, wherein, the controller is configured to set the initial value again when (i) the second game is executed the initial predetermined number of times and (ii) the display-use remaining number of game plays of the second game becomes zero.

3. The information processor according to claim 2, wherein, the controller is configured to hide the display-use remaining number of game plays of the second game when the display-use remaining number of game plays of the second game becomes zero as a result of execution of the second game.

4. The information processor according to claim 3, wherein, when the display-use remaining number of game plays of the second game becomes zero as a result of the execution of the second game, the controller displays a sign indicating a possibility, in which the second game state continues, in an area in which the display-use remaining number of game plays of the second game was displayed.

5. A game control method executed by a computer, comprising:
a process of switching, depending on a predetermined condition, a game state between (i) a first game state in which a first game which requires a bet is executed and (ii) a second game state in which a second game which does not require the bet is executed, the game state including the first game state and the second game state;
a process of displaying how the first game and the second game progress on a display;
a process of determining the number of execution times of the second game in the second game state;
when the second game is executed an initial predetermined number of times in the second game state, a process of setting the display-use remaining number of game plays of the second game to a value obtained by subtracting one from an initial value each time the second game is executed, the initial value being set to be smaller than the number of execution times of the second game, the display-use remaining number of game plays of the second game being displayed on the display as the remaining number of game plays of the second game; and
a process of setting the actual remaining number of game plays of the second game as the display-use remaining number of game plays of the second game when the second game is executed after the second game has been executed the initial predetermined number of times.

6. A game control method executed by a computer, comprising:
a process of switching, depending on a predetermined condition, a game state between (i) a first game state in which a first game which requires a bet is executed and (ii) a second game state in which a second game which does not require the bet is executed, the game state including the first game state and the second game state;
a process of displaying how the first game and the second game progress on a display;
a process of determining the number of execution times of the second game in the second game state; and
a process of executing the second game the number of all the execution times in the second game state while a value smaller than the number of the execution times of the second game is repeatedly counted down.
